(19) United States
(12) Patent Application Publication
(10) Pub. No.: US 2011/0316684 A1
(43) Pub. Date: Dec. 29, 2011

(54) REMOTE KEYLESS ENTRY FOB

(76) Inventor: ERIC D. MOULTON, Marysville, OH (US)

(21) Appl. No.: 12/821,878

(22) Filed: Jun. 23, 2010

(51) Int. Cl. B60R 25/10

(52) U.S. Cl. 340/426.36

(57) ABSTRACT

The present invention relates to a remote keyless FOB for manipulating functions on a vehicle comprising: a housing, where the housing includes a top side and a bottom side; a lock button, an illuminating indicator and a unlock button on the top side; a depression button on the bottom side; a back light under the indicator; and a power source within the housing. The depression button may include a plurality of LED lights. The remote keyless FOB also includes a timer that provides a means to set the illuminating indicator to a preset time period for illumination. In one exemplary embodiment, the indicator illuminates a back-lit inscription of the word “LOCKED” stamped into a plastic housing.

### BACKGROUND OF THE INVENTION

1. Field of Invention

The present invention relates to a remote keyless entry FOB that includes illumination to confirm an active locked position.

2. Description of Related Art

Remote keyless entry systems have been developed for entry into vehicles that provide a means for transmitting a signal to lock and unlock a vehicle from a remote position. Remote keyless entry systems use signals to transmit via modulated radio frequency or via infrared signal. Signals received by the receiver within the vehicle causes mechanisms to lock and unlock access to the vehicle. Remote keyless entry systems are used on most vehicles currently in the marketplace. Many of the remote keyless entry FOBs include various buttons that are depressed for functions related to the use thereof. The typical buttons used on a FOB include a lock, unlock, horn, trunk release, and emergency alert. Many times when these buttons are depressed, the user assumes that the correct button has been depressed.

Examples of remote keyless entry FOBs include U.S. Pat. No. 5,850,188 that discloses a remote keyless entry apparatus for use with a vehicle. The remote keyless entry apparatus of the '188 patent includes a key FOB transmitter having a diagnostic gathering and storage means. The FOB includes a diagnostic gathering of various diagnostic data associated with the vehicle in addition to providing the control means for entry and exit of the vehicle. U.S. Pat. No. 6,980,095 discloses a remote keyless entry FOB that includes electroluminous features. Illumination is provided for the various buttons and keys on the remote keyless entry device.

### SUMMARY OF THE INVENTION

The present invention relates to a remote keyless FOB for manipulating functions on a vehicle comprising: a housing, where the housing includes a top side; a lock button, an illuminating indicator and a unlock button on the top side; a plurality of LED lights under the illuminating indicator; and a power source within the housing. The remote keyless FOB may also includes an optional programmable timer that provides a means to set the illuminating indicator to a preset time period for illumination. In one exemplary embodiment, the indicator illuminates a back-lit inscription of the word “LOCKED” stamped into a plastic housing when the lock button is depressed the plurality of LED lights will illuminate the “LOCKED” stamped into the housing.

### BRIEF DESCRIPTION OF DRAWINGS

FIG. 1 depicts a view of the interior of a remote keyless entry FOB according to the present invention.

FIG. 2 depicts a top view of the remote keyless entry FOB according to the present invention.

### DETAILED DESCRIPTION

The present invention relates to a remote keyless entry FOB used to lock and unlock a vehicle that includes an illuminated indicator of a locked position. The present invention has a lighted indicator that indicates that the vehicle has been placed into a locked position and remains illuminated for a set period of time. This feature provides the user with a visual affirmation that the vehicle has been locked and a reminder for a predetermined period of time that the vehicle is indeed in the locked position.

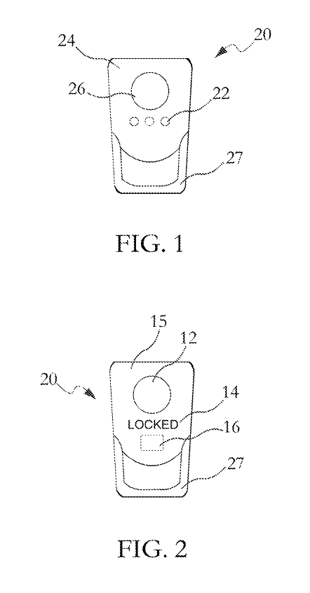

FIGS. 1A through 1C depict views of a depression pad 21 that is placed upon a bottom side of a keyless entry FOB 20 according to the present invention. The depression pad 21 as shown in the side view of FIG. 1A includes a LED light 22A on one side as depicted from the side view. The top view of the Pad 21 shows that three LED lights are positioned along the perimeter of the depression pad 21. The LED lights 22A, 22B, 22C are evenly spaced along the outer part of the depression pad 21. A transparent plastic cover 24 is provided at the center of the depression pad 21. The depression pad 21 is adhered to the bottom side of the keyless entry FOB 20 shown in FIG. 1D. The bottom side 28 includes a depression 25 that receives the depression pad 21.

The keyless entry FOB 20 includes an outer ring 27 that extends from one side thereof. The ring 27 provides a means to attach the keyless entry FOB 20 to a key ring or other attachment means to secure the FOB 20 for access by the user. The pad 21 includes an adhesive side 23 depicted in FIG. 1C that adheres to the depression 25 at one place on the bottom side 28 of the keyless entry FOB 20.

FIG. 2 depicts a top side 15 view of the entry FOB 20. As shown on the top side 15, a lock button 12 and unlock button 16 are provided for use with the keyless entry FOB 20. Between the two buttons, an illuminated indicator 14 is provided. The illuminated indicator 14 includes a back-lit inscription of the word “LOCKED” stamped into a plastic housing. A back light is provided that goes in the on position when the user depresses the lock button 12 in conjunction with the depression pad 21 on the bottom side 28 of the FOB 20.

A timer exists within the keyless entry FOB 20 that has a pre-determined time associated with the illumination of the indicator 14. The timer may set a pre-determined amount of time for the illumination of the indicator 14. Upon the expiration of the pre-determined time period, the indicator goes to an unlit position and the FOB remains in a stable state until used for entry into the vehicle. A battery within the housing of the FOB 20 powers the FOB 20 and in one particular embodiment may be a small lithium battery.

The FOB 20 according to the present invention provides a visual indication of a locked position when used to lock a vehicle. The illumination is emitted for a predetermined period of time upon activation of the locked button. The FOB 20 according to the present invention provides a means to reassure the user that the vehicle has been placed in a locked position and therefore the user also may have a reminder that the vehicle is in a locked position when they reach their destination which may be inside their home or office. This visual indication removes the guesswork and provides a means of assurance that the vehicle has been placed in a locked position. The instant invention has been shown and described in what it considers to be the most practical and preferred embodiments. It is recognized, however, that departures may be made there from within the scope of the invention and that obvious modifications will occur to a person skilled in the art.

What is claimed is:

1. A remote keyless FOB for manipulating functions on a vehicle comprising:
a. a housing, where the housing includes a top side and a bottom side;
b. a lock button, an illuminating indicator and a unlock button on the top side;
c. a depression button on the bottom side;
d. a back light under the indicator; and
e. a power source within the housing.

2. The remote keyless FOB according to claim 1, where said depression button includes a plurality of LED lights.

3. The remote keyless FOB according to claim 1, further including a timer, where said timer provides a means to set the illuminating indicator to a preset time period for illumination.

4. The remote keyless FOB according to claim 3, where the indicator illuminates a back-lit inscription of the word “LOCKED” stamped into a plastic housing.
